(19) United States
(12) Patent Application Publication
(10) Pub. No.: US 2016/0006614 A1
(43) Pub. Date: Jan. 7, 2016

(54) Source Routing Using Path Computation Elements

(71) Applicant: Futurewei Technologies, Inc., Plano, TX (US)

(72) Inventor: Qianglin Quintin Zhao, Boxborough, MA (US)

(21) Appl. No.: 14/789,675

(22) Filed: Jul. 1, 2015

Related U.S. Application Data
(60) Provisional application No. 62/020,830, filed on Jul. 3, 2014.

(51) Int. Cl. H04L 12/24

(52) U.S. Cl. CPC H04L 41/0816; H04L 41/12

(57) ABSTRACT

A network configuring method including receiving a label switched path (LSP) tunnel request from a path computation element (PCE), computing an LSP path, sending an LSP initiation message that comprises a label stack for the LSP path computed to the PCE, receiving an LSP delegation message from the PCE, and sending a label entry update message that comprises the label stack to PCEs along the computed LSP. A network configuring method including sending an LSP tunnel request to a path computation element central controller (PCECC), receiving an LSP initiation message that comprises a label stack for a computed LSP path from the PCECC, creating an LSP tunnel using the label stack, sending an LSP delegation message to the PCECC, receiving a label entry update message that comprises the label, and obtaining the label stack using the label entry update message.

### CROSS-REFERENCE TO RELATED APPLICATIONS

The present application claims benefit of U.S. Provisional Patent Application No. 62/020,830 filed Jul. 3, 2014 by Qianglin Quintin Zhao and entitled “Path Computation Element for Source Routing,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Multiprotocol label switching (MPLS) networks are widely deployed in service provider networks. Current MPLS networks are very complex to operate and maintain because of label distribution protocol (LDP) and Resource Reservation Protocol (RSVP)—Traffic engineering (TE) MPLS signaling protocols that are needed to configure the MPLS networks. Established label switched paths (LSPs) need to maintain a lot of states in each forwarding device in the MPLS network. Conventional systems may use source routing-based segment routing technologies, which use node and link adjacencies to identify explicit paths. These systems use the existing integrated services digital network (ISDN) architecture to reduce the complexity of an MPLS network by extending the interior gateway protocol (IGP) to propagate MPLS labels. Using IGP to propagate MPLS labels removes LDP and RSVP-TE signaling protocols from the architecture. This shifts the complexity of configuring an MPLS network, but does not simplify the process for configuring the MPLS network. It is desirable to have a system that leverages existing infrastructure and reduces the complexity of MPLS networks.

### SUMMARY

In one embodiment, the disclosure includes a network configuring method comprising receiving a label switched path (LSP) tunnel request from a path computation element (PCE), computing an LSP path in response to the LSP tunnel request, sending an LSP initiation message that comprises a label stack for the LSP path computed to the PCE, receiving an LSP delegation message from the PCE, and sending a label entry update message that comprises the label stack to one or more PCEs along the LSP computed in response to the LSP delegation message.

In another embodiment, the disclosure includes a network configuring method comprising sending an LSP tunnel request to a path computation element central controller (PCECC), receiving an LSP initiation message that comprises a label stack for a computed LSP path from the PCECC, creating an LSP tunnel using the label stack, sending an LSP delegation message to the PCECC, receiving a label entry update message that comprises the label stack in response to the LSP delegation message, and obtaining the label stack using the label entry update message.

In yet another embodiment, the disclosure includes an apparatus comprising a transmitter configured to advertise path computation element communication protocol (PCEP) support to a network, send an LSP initiation message that comprises a label stack for an LSP path computed to a PCE, send a label entry update message that comprises the label stack to one or more PCEs along the computed LSP in response to an LSP delegation message, a receiver configured to receive an LSP tunnel request from the PCE and receive the LSP delegation message from the PCE, a memory, and a processor coupled to the transmitter, receiver, and memory, and configured to compute the LSP path in response to the LSP tunnel request.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an embodiment of a network configured to implement a path computation element communication protocol.

FIG. 2 is a diagram of an embodiment of a network element.

FIG. 3 is a protocol diagram for implementing multiprotocol label switching in a network using path computation elements and a path computation element communication protocol.

FIG. 4 is a diagram of an embodiment of a path computation element central controller capability type-length-value.

FIG. 5 is a diagram of an embodiment of a label object.

FIG. 6 is a diagram of an embodiment of a next-hop type-length-value.

FIG. 7 is a diagram of another embodiment of next-hop type-length-value.

FIG. 8 is a diagram of an embodiment of a forwarding equivalent class object.

FIG. 9 is a diagram of another embodiment of a forwarding equivalent class object.

FIG. 10 is a diagram of another embodiment of a forwarding equivalent class object.

FIG. 11 is a flowchart of an embodiment of a network configuring method.

FIG. 12 is a flowchart of another embodiment of a network configuring method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for reducing the complexity for configuring a multiprotocol label switching (MPLS) network using a path computation element (PCE) and a path computation element communication protocol (PCEP). Using PCEP allows an MPLS network to be configured without requiring an interior gateway protocol (IGP) extension and without requiring network nodes in the MPLS network to use Resource Reservation Protocol (RSVP)—Traffic engineering (TE) and label distribution protocol (LDP) signaling protocols. Using PCEP, link adjacencies to each network node in the MPLS network do not need to be advertised using IGP extensions. In an embodiment, a path computation element central controller (PCECC) is configured to generate and to use PCEP to distribute labels to network nodes for the MPLS network. Existing PCEs and PCEP functionalities are leveraged to provide source routing-based traffic engineering tunnels. This provides application-aware traffic engineering tunnels to a user. Using PCEP to configure an MPLS network may substantially reduce complexity associated with configuring an MPLS network, maintaining label switched path (LSP) states, and maintaining signaling states. PCEP can coexist with other PCE functionalities to provide a full set of MPLS functionalities, such as multicasting, without deploying the MPLS signaling protocol. Further, MPLS may be easier to migrate towards a software-defined network (SDN) and may be backwards compatible.

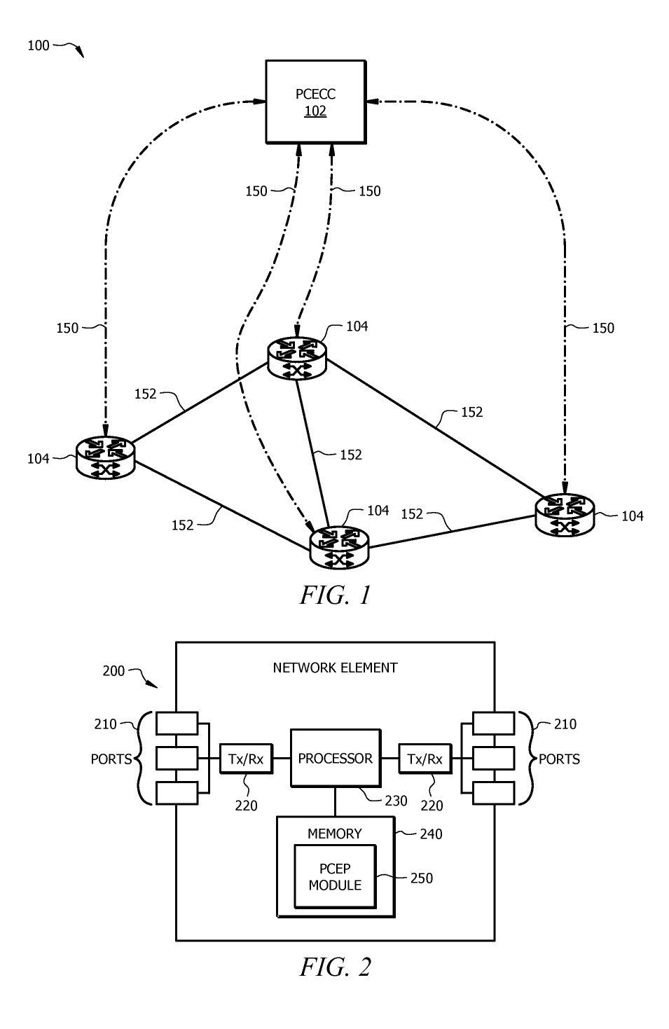

FIG. 1 is a diagram of an embodiment of a network 100 configured to implement PCEP. PCEP provides a mechanism for PCEs 104 to perform route computations in response to PCE requests. Segment routing technology leverages source routing and tunneling. A source network node can choose a path without relying on a hop-by-hop signaling protocol such as LDP and RSVP-TE.

Network 100 comprises a PCECC 102 in data communication with a plurality of PCEs 104. Network 100 may be configured as shown or in any other suitable configuration. PCECC 102 is a network device or a controller configured to use PCEP for distributing local and global segment routing labels such as MPLS labels. Typically, MPLS labels are local labels that are allocated by downstream network nodes to the upstream network node. Local labels are identified by the neighboring upstream network node and downstream network node. PCECC 102 is configured to exchange MPLS label information with PCEs 104 and to manage the MPLS labels for the network 100. For example, the PCECC 102 is configured to download and to distribute MPLS labels with the PCEs 104. PCECC 102 is also configured to generate a global label and to distribute the global label with the PCEs 104. Global labels are labels that may be identified by any network node within the network 100. Using local labels and global labels, the PCECC 102 supports unicast tunneling and multicast tunneling.

PCECC 102 is in data communication with the PCEs 104 using PCEP. In an embodiment, PCEP is implemented over a transmission control protocol (TCP) connection 150. PCEP is used to communicate path computations requests, local label information, and global label information. Additional details about PCEP are described in Internet Engineering Task Force (IETF) Request For Comments (RFC) 5440 titled, “Path Computation Element (PCE) Communication Protocol (PCEP),” by J P. Vassuer, et al., published in March 2009, which is hereby incorporated by reference as if reproduced in its entirety.

PCEs 104 are network devices or components that are capable of computing a network path or route based on a network graph and by applying computational constraints. PCEs 104 are configured to advertise a PCEP capability to the PCECC 102 to negotiate a label range for a group of clients. Each PCE 104 may be associated with one or more path computation clients (PCCs) (not shown). A PCC is a client application that is configured to request path computations to be performed by PCEs 104. A PCC may be configured to ask for a label range assignment, for example, using a path request message.

PCEs 104 are coupled to one another via one or more tunnels and/or links 152. Examples of tunnels include, but are not limited to, multiprotocol label switching (MPLS) tunnels and virtual extensible local area network (VxLAN) tunnels. Links may include physical links, such as electrical and/or optical links, and/or logical links (e.g., virtual links).

Additional details about PCECC 102, PCEs 104, PCC, and PCEP are described in IETF RFC draft titled, “The Use Cases for Using PCE as the Central Controller (PCECC) of LSPSs,” by Q. Zhao, et al., published on Jul. 4, 2014 and IETF RFC draft titled, “PCEP Procedures and Protocol Extensions for Using PCE as a Central Controller (PCECC) for LSPs,” by Q. Zhao, et al., published on Mar. 2, 2015, which are both hereby incorporated by reference as if reproduced in their entirety.

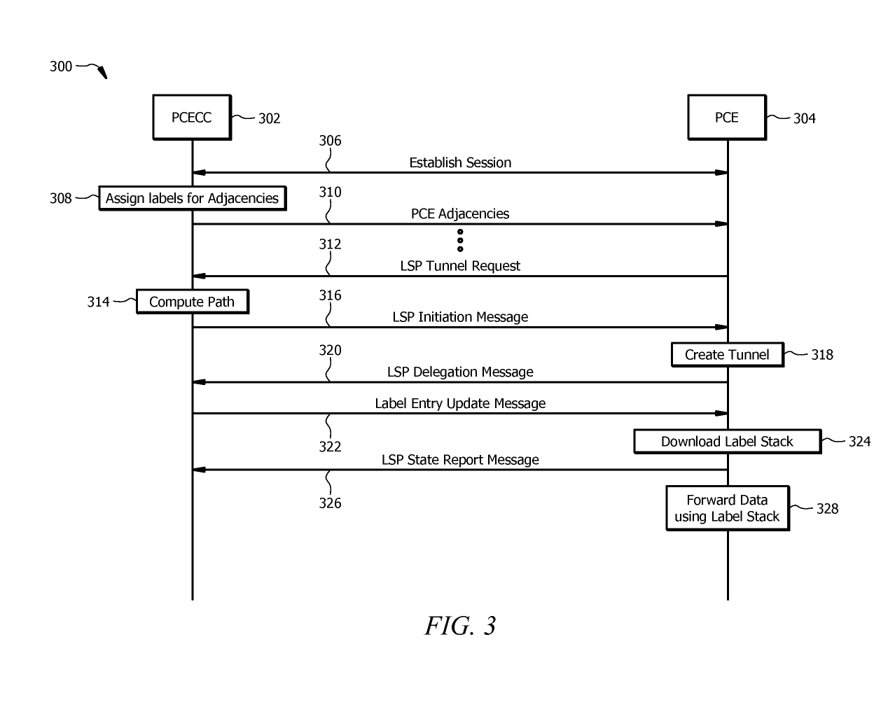

FIG. 2 is a diagram of an embodiment of a network element 200. The network element 200 may be suitable for implementing the disclosed embodiments. Network element 200 may be any device (e.g., a modem, a switch, router, bridge, server, client, controller, etc.) that transports or assists with transporting data through a network, system, and/or domain. For example, network element 200 may be implemented in a PCECC 102 or a PCE 104 in FIG. 1 or in a PCECC 302 or PCE 304 in FIG. 3. Network element 200 comprises ports 210, transceiver units (Tx/Rx) 220, a processor 230, and a memory 240 comprising a PCEP module 250. Ports 210 are coupled to Tx/Rx 220, which may be transmitters, receivers, or combinations thereof. The Tx/Rx 220 may transmit and receive data via the ports 210. Processor 230 is configured to process data. Memory 240 is configured to store data and instructions for implementing embodiments described herein. The network element 200 may also comprise electrical-to-optical (EO) components and optical-to-electrical (OE) components coupled to the ports 210 and Tx/Rx 220 for receiving and transmitting electrical signals and optical signals.

The processor 230 may be implemented by hardware and software. The processor 230 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 230 is in communication with the ports 210, Tx/Rx 220, and memory 240.

The memory 240 comprises one or more of disks, tape drives, or solid-state drives and may be used as an over-flow data storage device, to store programs when such programs are selected for execution, and to store instructions and data that are read during program execution. The memory 240 may be volatile or non-volatile and may comprise read-only memory (ROM), random-access memory (RAM), ternary content-addressable memory (TCAM), and static random-access memory (SRAM). PCEP module 250 is implemented by processor 230 to execute the instructions for configuring an MPLS network and for distributing label using PCEP. The inclusion of PCEP module 250 provides an improvement to the functionality of the network element 200. PCEP module 250 also effects a transformation of network element 200 to a different state. Alternatively, PCEP module 250 is implemented as instructions stored in the processor 230.

FIG. 3 is a protocol diagram 300 for implementing MPLS in a network using PCEs and a PCEP. The PCEP is employed to configure the network for MPLS and to distribute labels for routing data traffic. For example, configuring the network for MPLS and distributing labels for routing data traffic may be implemented when the network wants to provide MPLS functionalities. The network comprises a PCECC 302 in signal communication with a PCE 304. PCECC 302 is configured similarly to PCECC 102 and PCE 304 is configured similarly to PCE 104 in FIG. 1, respectively.

During a PCEP initialization phase, PCECC 302 and PCE 304 advertise their support for using PCEP to configure the network. For example, PCECC 302 and PCE 304 may include a PCECC capability type-length-value (TLV) in an OPEN object and may broadcast the OPEN object to advertise their support for PCEP. In an embodiment, the PCECC capability TLV may comprise a first flag that indicates a local label range reservation capability and a second flag that indicates a global label range reservation capability. Additional details about an OPEN object are described in IETF RFC 5440 titled, “Path Computation Element (PCE) Communication Protocol (PCEP),” by JP. Vassuer, et al., published in March 2009.

At step 306, PCECC 302 and PCE 304 establish a session. PCECC 302 and PCE 304 may establish a session using any suitable technique or protocol as would be appreciated by one of ordinary skill in the art upon viewing this disclosure. For example, PCECC 302 and PCE 304 may establish a transmission control protocol (TCP) session. At step 308, PCECC 302 assigns labels for adjacencies of PCE 304. PCECC 302 may associate labels with ports, links, or next-hops of PCE 304. Labels may comprise local labels or global labels. At step 310, PCECC 302 sends the labels for the adjacencies to PCE 304. PCECC 302 sends one or more PCLabelUpd messages to PCE 304. The PCLabelUpd message comprises a label object and, optionally, a forwarding equivalent class (FEC) object that is associated with the label object. The label object comprises labels and path information associated with the labels. The FEC object is an object that represents destinations which share the same forwarding path. PCE 304 downloads labels or updates a label mapping using the PCLabelUpd message. PCECC 302 may repeat steps 306-310 to send or advertise labels to other PCEs in the network. Additional details about PCLabelUpd messages are described in IETF RFC draft titled, “The Use Cases for Using PCE as the Central Controller (PCECC) of LSPSs,” by Q. Zhao, et al., published on Jul. 4, 2014 and IETF RFC draft titled, “PCEP Procedures and Protocol Extensions for Using PCE as a Central Controller (PCECC) for LSPs,” by Q. Zhao, et al., published on Mar. 2, 2015.

At step 312, PCE 304 sends an LSP tunnel request to PCECC 302. The LSP tunnel request indicates that PCE 304 is a head node and requests an LSP tunnel from PCE 304 to a tail or egress node. A head node is configured to receive path information and labels and to encapsulate data packets using the path information and labels. At step 314, PCECC 302 computes an LSP from PCE 304 to the tail node. For example, PCECC 302 may select a path based on the bandwidth requirements specified in an LSP tunnel request when there are a plurality of paths between PCE 304 and the tail node. The selected path satisfies the bandwidth requirements. PCECC 302 may also select a path based on the number of hops between PCE 304 and the tail node when more than one path satisfies the bandwidth requirements. PCECC 302 generates or obtains path information for the computed LSP. PCECC 302 may assign a new LSP identifier (ID) and may form a label stack for the computed LSP path. The label stack indicates next-hops along the computed LSP path. The PCECC 302 may compute the LSP path using any suitable technique as would be appreciated by one of ordinary skill in the art upon viewing this disclosure. For example, the LSP path may be computed based on a shortest distance, link weights, or other network constraints. At step 316, PCECC 302 sends an LSP initiation message to PCE 304. For example, the LSP initiation message is a PCInitiate message that indicates to PCE 304 to setup a PCE-initiated LSP. The PCInitiate message comprises a PCE Initiated LSP ID (PLSPID), a Tunnelid, the LSP ID, and the label stack. A PLSPID is an ID that is associated with a PCE-initiated LSP. A Tunnelid is a tunnel ID that is associated with one or more LSP IDs. An LSP ID is an ID for the LSP. Additional details about a PCInitiate message are described in IETF RFC draft titled, “PCEP Extensions for PCE-initiated LSP Setup in a Stateful PCE Model,” by E. Crabbe, et al., published on Apr. 17, 2015. At step 318, PCE 304 creates a tunnel in response to the PCInitiate message. PCE 304 creates a tunnel to one or more next-hops along the computed path based on the path information and the label stack. At step 320, PCE 304 sends an LSP delegation message to PCECC 302. The LSP delegation message indicates a transfer of ownership of an LSP from PCE 304 to PCECC 302. Ownership allows PCE 304 and PCECC 302 to set up and manage LSPs. PCE 304 sends a PCRpt message to PCECC 302. The PCRpt message comprises the PLSPID, the Tunnelid, the LSP ID, the label stack, and a status set to “going-up.” Additional details about a PCRpt message are described in IETF RFC draft titled, “PCEP Extensions for Stateful PCE,” by E. Crabbe, et al., published on Apr. 20, 2015. At step 322, PCECC 302 sends a label entry update message to PCE 304 and each network node along the LSP. The label entry update message provides path information and the label stack for the LSP. PCECC 302 sends a PCLabelUpd message to PCE 304 and the other network nodes along the LSP. The PCLabelUpd message comprises a label object that comprises the PLSPId, the Tunnelid, the LSP ID, and the label stack. Optionally, the PCLabelUpd message may also comprise an FEC object. At step 324, PCE 304 downloads and obtains the label stack from the label entry update message. At step 326, PCE 304 sends an LSP state report message to PCECC 302. The LSP state report message indicates the status of PCE 304. For example, the LSP state report message indicates whether an LSP is up (e.g., active) or down (e.g., inactive). At step 328, PCE 304 forwards data using the label stack. For example, PCE 304 encapsulates a data packet with a header that comprises the label stack and forwards the data packet in accordance with the labels in the label stack. The next-hop network nodes may process the data packet using existing MPLS procedures. For example, a next-hop network node receives the data packet, removes a first label from the label stack, and forwards the data packet in accordance with a second label in the label stack.

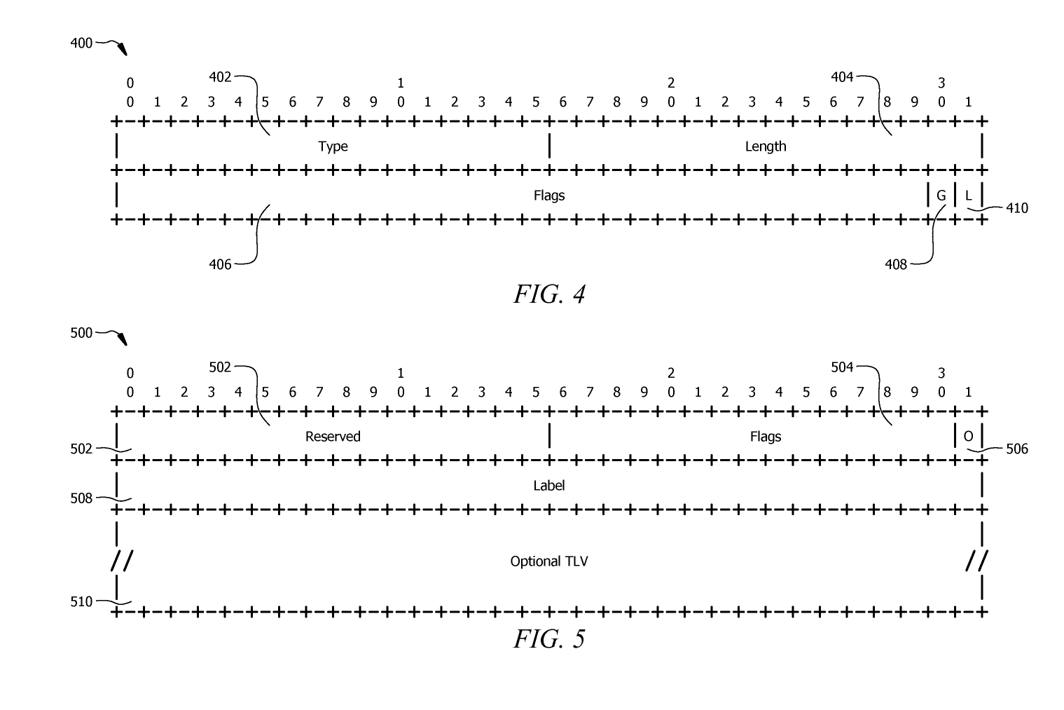

FIG. 4 is a diagram of an embodiment of a PCECC capability type-length-value (TLV) 400. PCECC capability TLV 400 is used in an OPEN object to advertise PCECC capabilities. Advertising PCECC capabilities indicates that a PCE supports LSPs that are setup using PCEP. PCECC capability TLV 400 comprises a type field 402, a length field 404, and a flags field 406. Type field 402 may be about four octets and indicates a type that is associated with the PCECC capability TLV 400. Length field 404 may be about four octets and may indicate the length of the PCECC capability TLV 400, for example, in bytes. Flags field 406 may be about 32 bits and indicates capabilities associated with the PCECC capability TLV 400. For example, flags field 406 may comprise a global label range capability bit 408 that indicates a network node is capable for local label range reservation and a local label range capability bit 410 that indicates a network node is capable for global label range reservation. PCECC capability TLV 400 may be configured as shown or in any other suitable configuration.

FIG. 5 is a diagram of an embodiment of a label object 500. Label object 500 is used to specify label information that is carried within a PCLabelUpd message. Label object 500 comprises a reserved field 502, a flags field 504, a label field 508, and an optional TLV field 510. Flags field 504 may be about 16 bits and may be used to carry information that is associated with the label. For example, flags field 504 comprises an out-label (0) bit 506 that indicates the label in the label field 508 is an out label and is used to encode the next-hop information. For example, the label is used to encapsulate a data packet before the data packet is sent out through an outgoing interface. Out-label bit 506 may also indicate whether the label object comprises optional TLVs. Label field 508 may be about 32 bits and may provide label information. In an embodiment, the label information may be encoded such that the rightmost bits represent a label. Optional TLV field 510 comprises optional TLVs such as next-hop TLVs. In an embodiment, optional TLV field 510 comprises a next-hop TLV when the out-label bit 506 is set to one and comprises zero TLVs when the out-label bit 506 is set to zero. Label object 500 may be configured as shown or in any other suitable configuration.

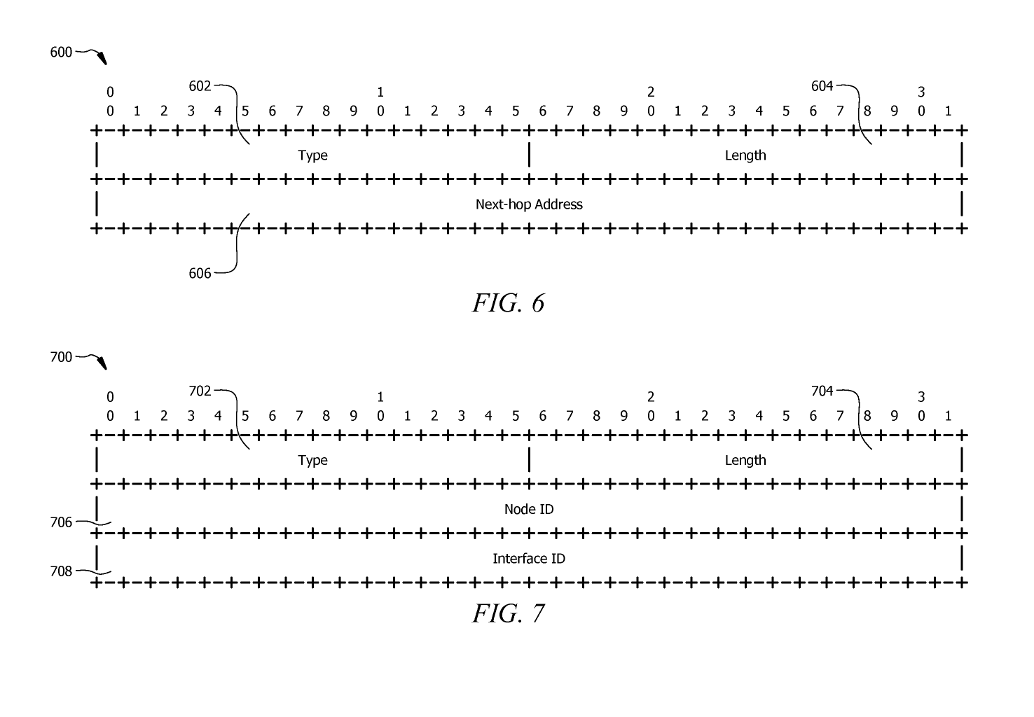

FIG. 6 is a diagram of an embodiment of a next-hop TLV 600. Next-hop TLV 600 may be carried within a label object (e.g., label object 500 in FIG. 5) to provide next-hop information. Next-hop TLV 600 comprises a type field 602, a length field 604, and a next-hop address field 606. Type field 602 may be about four octets and indicates a type that is associated with the next-hop TLV 600. Length field 604 may be about four octets and may indicate the length of the next-hop TLV 600, for example, in bytes. Next-hop address field 606 may be about 32 bits and indicates an address associated with a next-hop. For example, the address may be an Internet Protocol (IP) version 4 (IPv4) address or an IP version 6 (IPv6) address. Next-hop TLV 600 may be configured as shown or in any other suitable configuration.

FIG. 7 is a diagram of another embodiment of next-hop TLV 700. Next-hop TLV 700 may be carried within a label object (e.g., label object 500 in FIG. 5) to provide next-hop information. Next-hop TLV 700 comprises a type field 702, a length field 704, a node-ID field 706, and an interface-ID field 708. Type field 702 may be about four octets and indicates a type that is associated with the next-hop TLV 700. Length field 704 may be about four octets and may indicate the length of the next-hop TLV 700, for example, in bytes. Node-ID field 706 may be about 32 bits and indicates an ID that is associated with a next-hop. Interface-ID field 708 may be about 32 bits and indicates an ID for an interface that is associated with the next-hop. Next-hop TLV 700 may be configured as shown or in any other suitable configuration.

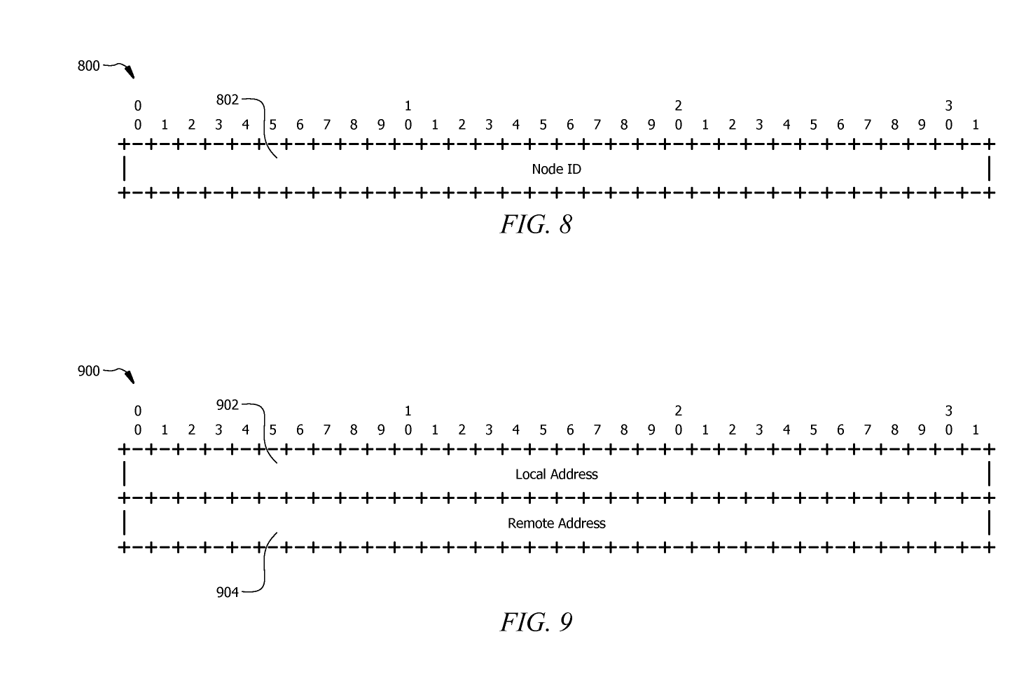

FIG. 8 is a diagram of an embodiment of an FEC object 800 that is used to provide FEC information. FEC object 800 may be carried within a PCLabelUpd message. FEC object 800 comprises a node ID address field 802. The node ID address field 802 may be about 32 bits and may contain an IPv4 address or an IPv6 address.

FIG. 9 is a diagram of another embodiment of an FEC object 900 that is used to provide FEC information. FEC object 900 may be carried within a PCLabelUpd message. FEC object 900 comprises a local address field 902 and a remote address field 904 for an adjacency. The local address field 902 and the remote address field 904 may each be about 32 bits and may contain an IPv4 address or an IPv6 address for the adjacency.

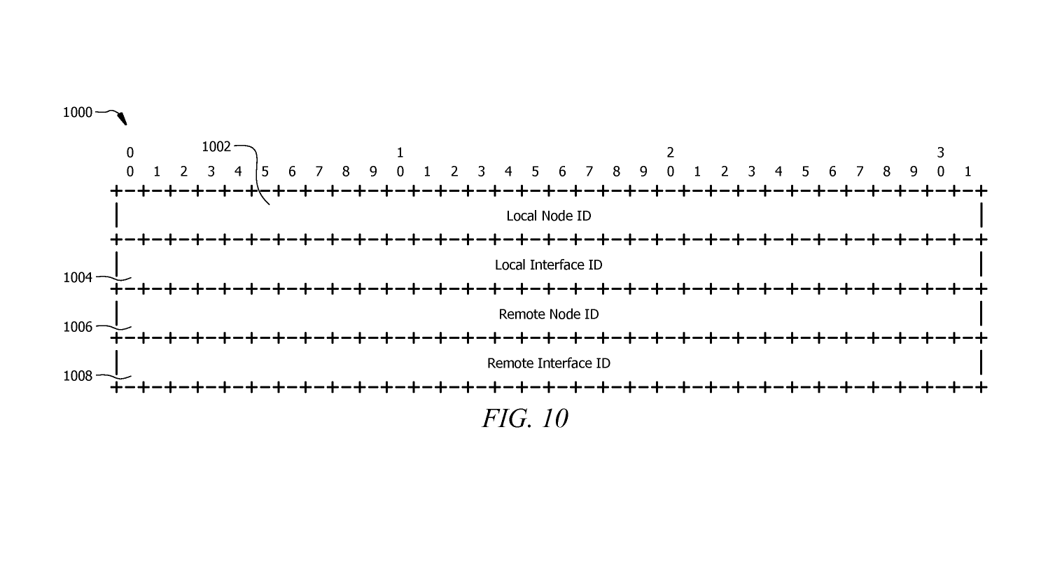

FIG. 10 is a diagram of another embodiment of an FEC object 1000 that is used to provide FEC information. FEC object 1000 may be carried within a PCLabelUpd message. FEC object 1000 comprises a local node ID field 1002, a local interface ID field 1004, a remote node ID field 1006, and a remote interface ID field 1008. Local node ID field 1002, local interface ID field 1004, remote node ID field 1006, and remote interface ID field 1008 may each be about 32 bits. Local node ID field 1002 indicates an ID for a local network node that is associated with an adjacency. Local interface ID field 1004 indicates an ID for a local interface that is associated with the adjacency. Remote node ID field 1006 indicates an ID for a remote network node that is associated with an adjacency. Remote interface ID field 1008 indicates an ID for a remote interface that is associated with the adjacency.

Additional details for a PCECC capability TLV, a label object, a next-hop TLV, and an FEC object are described in IETF RFC draft titled, “PCEP Procedures and Protocol Extensions for Using PCE as a Central Controller (PCECC) for LSPs,” by Q. Zhao, et al., published on Mar. 2, 2015.

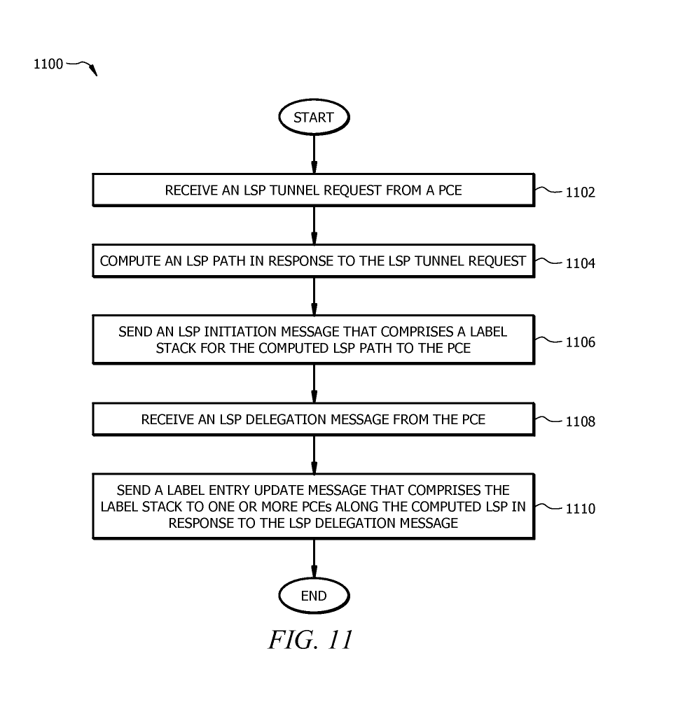

FIG. 11 is a flowchart of an embodiment of a network configuring method 1100. Method 1100 is implemented by a PCECC to establish an LSP within a network. For example, method 1100 may be implemented in response to a request for an LSP from a PCE. A PCECC may be configured similarly to PCECC 102 in FIG. 1, network element 200 in FIG. 2, and PCECC 302 in FIG. 3.

At step 1102, the PCECC receives an LSP tunnel request from a PCE. The LSP tunnel request may request an LSP tunnel to be established between the PCE and a tail node. Receiving an LSP tunnel request from the PCE may be similar to as described in step 312 in FIG. 3. At step 1104, the PCECC computes an LSP path in response to the LSP tunnel request. The PCECC may compute the LSP path between the PCE and the tail node using any suitable technique as would be appreciated by one of ordinary skill in the art upon viewing this disclosure. Computing the LSP path may be similar to as described in step 314 in FIG. 3. At step 1106, the PCECC sends an LSP initiation message that comprises a label stack for the computed LSP path to the PCE. The LSP initiation message indicates to setup a PCE-initiated LSP. Sending the LSP initiation message may be similar to as described in step 316 in FIG. 3. At step 1108, the PCECC receives an LSP delegation message from the PCE. The LSP delegation message indicates a transfer of ownership of an LSP from the PCE to the PCECC. Receiving the LSP delegation message may be similar to as described in step 320 in FIG. 3. At step 1110, the PCECC sends a label entry update message that comprises the label stack to one or more PCEs along the computed LSP in response to the LSP delegation message. The label entry update message provides path information and the label stack for the LSP. Sending the label entry update message may be similar to as described in step 322 in FIG. 3.

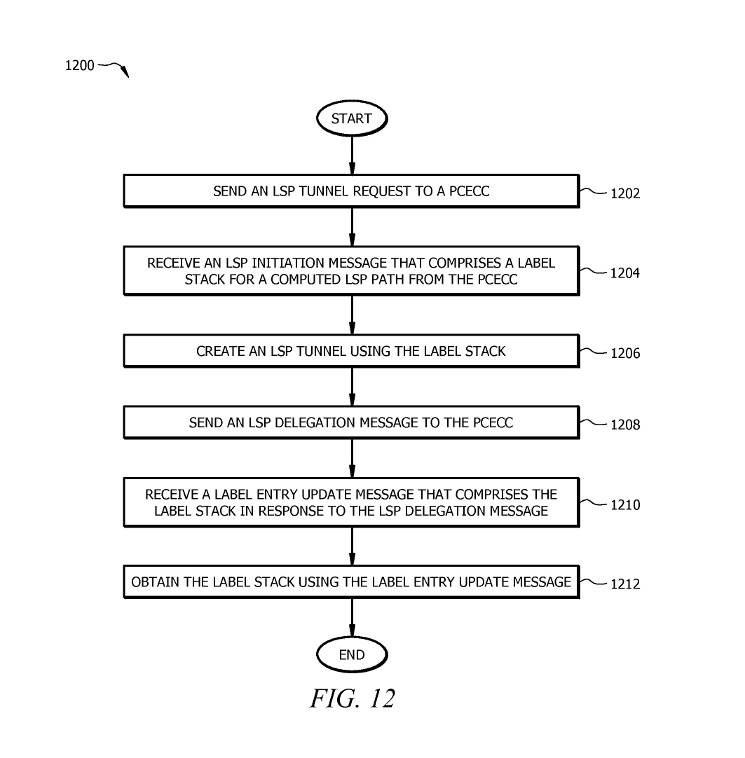

FIG. 12 is a flowchart of another embodiment of a network configuring method 1200. Method 1200 is implemented by a PCE to establish an LSP within a network. For example, method 1200 may be implemented to communicate data to another PCE. A PCE may be configured similarly to PCE 104 in FIG. 1, network element 200 in FIG. 2, and PCE 304 in FIG. 3.

At step 1202, the PCE sends an LSP tunnel request to a PCECC. The LSP tunnel request may request an LSP tunnel to be established between the PCE and a tail node. Sending the LSP tunnel request may be similar to as described in step 312 in FIG. 3. At step 1204, the PCE receives an LSP initiation message that comprises a label stack for a computed LSP path from the PCECC. The LSP initiation message indicates to setup a PCE-initiated LSP. Receiving the LSP initiation message may be similar to as described in step 316 in FIG. 3. At step 1206, the PCE creates an LSP tunnel using the label stack. Creating the LSP tunnel may be similar to as described in step 318 in FIG. 3. At step 1208, the PCE sends an LSP delegation message to the PCECC. The LSP delegation message indicates a transfer of ownership of an LSP from the PCE to the PCECC. Sending the LSP delegation message may be similar to as described in step 320 in FIG. 3. At step 1210, the PCE receives a label entry update message that comprises the label stack in response to the LSP delegation message. The label entry update message provides path information and the label stack for the LSP. Receiving the label entry update message may be similar to as described in step 322 in FIG. 3. At step 1212, the PCE obtains the label stack using the label entry update message. Obtaining the label stack may be similar to as described in step 324 in FIG. 3.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A network configuring method comprising:
a path computation element central controller (PCECC) receiving a label switched path (LSP) tunnel request from a path computation element (PCE);
the PCECC computing an LSP path in response to the LSP tunnel request;
the PCECC sending an LSP initiation message that comprises a label stack for the LSP path computed to the PCE;
the PCECC receiving an LSP delegation message from the PCE; and
the PCECC sending a label entry update message that comprises the label stack to one or more PCEs along the LSP computed in response to the LSP delegation message.

2. The method of claim 1, wherein the label stack comprises local labels.

3. The method of claim 1, wherein the label stack comprises global labels.

4. The method of claim 1, wherein sending the LSP initiation message comprises using a path computation element communication protocol (PCEP).

5. The method of claim 1, further comprising the PCECC advertising labels for a network.

6. The method of claim 1, further comprising the PCECC advertising support for a path computation element communication protocol (PCEP).

7. A network configuring method comprising:
A path computation element (PCE) sending a label switched path (LSP) tunnel request to a path computation element central controller (PCECC);
the PCE receiving an LSP initiation message that comprises a label stack for a computed LSP path from the PCECC;
the PCE creating an LSP tunnel using the label stack;
the PCE sending an LSP delegation message to the PCECC;
the PCE receiving a label entry update message that comprises the label stack in response to the LSP delegation message; and
the PCE obtaining the label stack using the label entry update message.

8. The method of claim 7, wherein the label stack comprises local labels.

9. The method of claim 7, wherein the label stack comprises global labels.

10. The method of claim 7, wherein receiving the LSP initiation message comprises using a path computation element communication protocol (PCEP).

11. The method of claim 7, further comprising the PCE receiving labels for a network.

12. The method of claim 7, further comprising the PCE advertising support for a path computation element communication protocol (PCEP).

13. The method of claim 7, further comprising the PCE creating an LSP tunnel using the label stack.

14. The method of claim 7, further comprising the PCE sending an LSP state report message.

15. An apparatus comprising:
a transmitter configured to:
advertise path computation element communication protocol (PCEP) support to a network;
send a label switched path (LSP) initiation message that comprises a label stack for an LSP path computed to a path computation element (PCE);
send a label entry update message that comprises the label stack to one or more PCEs along the computed LSP in response to an LSP delegation message;
a receiver configured to:
receive an LSP tunnel request from the PCE; and
receive the LSP delegation message from the PCE;
a memory; and
a processor coupled to the transmitter, receiver, and memory, and configured to compute the LSP path in response to the LSP tunnel request.

16. The apparatus of claim 15, wherein the label stack comprises local labels.

17. The apparatus of claim 15, wherein the label stack comprises global labels.

18. The apparatus of claim 15, wherein the processor is configured to send the LSP initiation message comprises using PCEP.

19. The apparatus of claim 15, the processor is configured to assign labels for a plurality of PCEs in a network.

20. The apparatus of claim 18, the processor is configured to send the labels to the plurality of PCEs in the network.
